(19) United States
(12) Patent Application Publication
(10) Pub. No.: US 2012/0084192 A1
(43) Pub. Date: Apr. 5, 2012

(54) System and Method for Coordinated Sales and Implementation of Financial Products

(75) Inventors: Carol Lynn Guyton, Bloomfield Hills, MI (US); Susan Scher, Reisterstown, MD (US)

(73) Assignee: Bank of America Corporation, Charlotte, NC (US)

(21) Appl. No.: 13/034,832

(22) Filed: Feb. 25, 2011

Related U.S. Application Data
(60) Provisional application No. 61/388,179, filed on Sep. 30, 2010.

(51) Int. Cl. G06Q 40/00

(52) U.S. Cl. 705/37

(57) ABSTRACT

Systems and methods for the coordinated sales and implementation of financial products are disclosed. In accordance with embodiments of the present disclosure, an apparatus may include a network interface and a processor coupled to the network interface. The network interface may be configured to receive a request for a client's purchase of a financial product, the request including client information. The processor may be configured to execute logic to (i) generate implementation documents based at least on the client information, the implementation documents comprising documents to be completed as a prerequisite to issuance of the financial product; (ii) schedule a follow-up meeting relating to purchase of the financial product based at least on the client information; and (iii) contemporaneously electronically display implementation documents to a client and an implementation advisor to facilitate the implementation advisor's assistance to the client in completing the implementation documents.

### RELATED APPLICATION

This application is related to, and claims the benefit of, U.S. Provisional Application No. 61/388,179, filed Sep. 30, 2010, which is incorporated by reference herein in its entirety.

### TECHNICAL FIELD OF THE INVENTION

The present disclosure relates generally to transaction processing, and more particularly to a system and method for coordinated sales and implementation of financial products.

### BACKGROUND

In many enterprises, sales and ultimate fulfillment of a product or service to be provided by the enterprise may be facilitated by numerous employees or agents of the enterprise. For example, in a financial institution sales and service representatives responsible for advising clients or potential clients regarding purchases of financial products and agents responsible for performing tasks to facilitate fulfillment of such financial products may be dispersed across an enterprise and may be managed by leaders from different lines of businesses and geographic regions. In many instances, the coordination and management, or lack thereof, between sales representatives and fulfillment representatives may lead to poor client experience for some client demographics in which a client may exit or otherwise not complete the post-sale implementation process.

### SUMMARY

In accordance with the present disclosure, the disadvantages and problems associated with prior systems and methods for fulfillment workflow have been substantially reduced or eliminated.

In accordance with embodiments of the present disclosure, an apparatus may include a network interface and a processor coupled to the network interface. The network interface may be configured to receive a request for a client's purchase of a financial product, the request including client information. The processor may be configured to execute logic to (i) generate implementation documents based at least on the client information, the implementation documents comprising documents to be completed as a prerequisite to issuance of the financial product; (ii) schedule a follow-up meeting relating to purchase of the financial product based at least on the client information; and (iii) contemporaneously electronically display implementation documents to a client and an implementation advisor to facilitate the implementation advisor's assistance to the client in completing the implementation documents.

In accordance with additional embodiments of the present disclosure, a tangible computer readable medium may include logic. The logic may be configured to, when executed on a processor, (i) receive a request for a client's purchase of a financial product, the request including client information; (ii) generate implementation documents based at least on the client information, the implementation documents comprising documents to be completed as a prerequisite to issuance of the financial product; (iii) schedule a follow-up meeting relating to purchase of the financial product based at least on the client information; and (iv) contemporaneously electronically display implementation documents to a client and an implementation advisor to facilitate the implementation advisor's assistance to the client in completing the implementation documents.

In accordance with further embodiments of the present disclosure, a method may include: (i) receiving, by a workflow manager, a request for a client's purchase of a financial product, the request including client information; (ii) generating, by the workflow manager, implementation documents based at least on the client information, the implementation documents comprising documents to be completed as a prerequisite to issuance of the financial product; (iii) scheduling, by the workflow manager, a follow-up meeting relating to purchase of the financial product based at least on the client information; and (iv) contemporaneously electronically displaying, by the workflow manager, implementation documents to a client and an implementation advisor to facilitate the implementation advisor's assistance to the client in completing the implementation documents.

### BRIEF DESCRIPTION OF THE DRAWINGS

FIG. 1 illustrates a system for coordinated sales and implementation of financial products, in accordance with particular embodiments of the present disclosure; and

FIG. 2 illustrates a method for coordinated sales and implementation of financial products, in accordance with particular embodiments of the present disclosure.

### DETAILED DESCRIPTION OF THE INVENTION

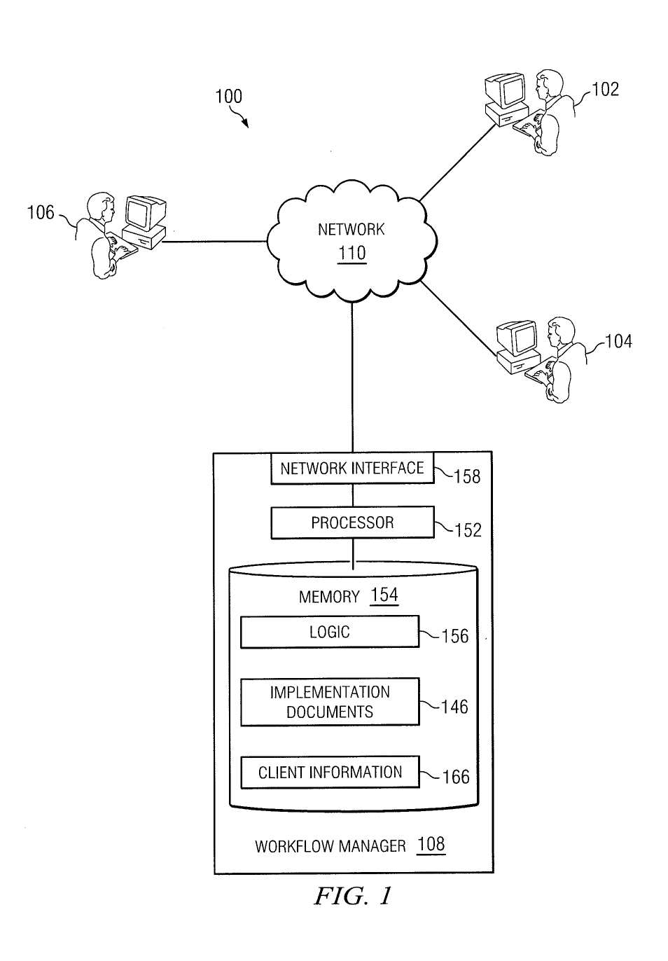

A system and method for coordinated sales and implementation of financial products is disclosed. FIG. 1 illustrates a system 100 for coordinated sales and implementation of financial products, in accordance with particular embodiments of the present disclosure. As shown in FIG. 1, system 100 may include a sales representative 102, an implementation representative 104, a client 106, and a workflow manager 108. Sales representative 102, implementation representative 104, client 106, and workflow manager 108 may be communicatively coupled by network 110.

Client 106 may represent any person that may submit or communicate assent to a sales representative 102 for acquisition of a financial product (e.g., deposit account, loan, credit account, money market account, stock, bond, annuity, financial security, a letter of credit, a line of credit, a mortgage, or any other suitable financial product) from an enterprise. For example, in some instances, client 106 may include a customer or potential customer who desires to acquire a particular financial product from an enterprise. Client 106 may communicate such assent to sales representative 102 in-person (e.g., via verbal or delivered written instructions), via electronic communication (e.g., a telephonic conversation, e-mail, web form submission, or other communication via network 110).

Sales representative 102 represents any person who may communicate with a client 106 to recommend to client 106 the purchase of one or more financial products from an enterprise. In some embodiments, sales representative 102 may be an employee or agent of the enterprise from which the financial product may be acquired. Implementation representative 104 may represent any person who may manage the completion, execution, and submission of documents, (e.g., deposit agreements, loan agreements, legal documents, etc.) required by the enterprise (e.g., in accordance with business practices and policies of the enterprise) and/or by applicable law in order to issue a particular financial product. In some embodiments, implementation representative 104 may be an employee or agent of the enterprise from which the financial product may be acquired. In some embodiments, sales representative 102 and implementation representative 104 may represent and/or be employed by the same enterprise.

Workflow manager 108 may comprise any system to which a sales representative 102, implementation representative 104, and/or client 106 may interface in order to facilitate completion of a purchase of a financial product, as described in this disclosure. In some embodiments, workflow manager 108 may comprise a computing system.

In some embodiments, workflow manager 108 may be configured to generate a display to and/or request information from a client 106 to facilitate communication of the client's assent to acquisition of a financial product. For example, workflow manager 108 may be configured to display information to client 106 via a web browser executing on a computing system to which client 106 is interfaced, and may receive information, including assent to acquire a particular financial product, that client has input into the web browser. It is understood that in some embodiments, client 106 may communicate assent to acquire a particular financial product in other ways, including in-person with sales representative (e.g., via verbal or delivered written instructions), or via other electronic communication (e.g., a telephonic conversation, e-mail, or other communication via network 110).

Workflow manager 108 may be configured to generate a display to and/or request information from sales representative 102 to facilitate implementation of a financial product. For example, after receiving client 106 assent to acquisition of a financial product, sales representative 102 may communicate to workflow manager 108 client information 166 regarding client 106 (e.g., client identity and demographic information, financial product to be acquired, availability for follow-up contact, etc.).

In response to and based on entry of client information 166, workflow manager 108 may generate implementation documents 146 for the financial product to be acquired. For example, based on the financial product to be acquired, workflow manager 108 may generate one or more implementation documents 146 (e.g., deposit agreements, loan agreements, legal documents, etc.) required by the enterprise (e.g., in accordance with business practices and policies of the enterprise) and/or by applicable law to be completed for issuance of the financial product, and store such implementation documents (e.g., on memory 154). In addition, based on client identity and demographic information, workflow manager 108 may populate implementation documents 146 with client-specific information to be included in implementation documents 146. In addition, based at least on client information 166 (and possibly also based on availabilities of sales representative 102 and implementation representative 104), workflow manager 108 may determine a suitable time for implementation representative 104 to contact client 106 in connection with completion of implementation documents 166, and may schedule a call or other meeting among client 106, implementation representative 104, and/or sales representative 102 based at least on such availability. Workflow manager 108 may also be configured to communicate a message to client 106, implementation representative 104, and/or sales representative 102 regarding the scheduled call.

Moreover, workflow manager 108 may also be configured to allow implementation representative 104 and client 106 to electronically co-browse implementation documents 146 to facilitate completion of implementation documents 146 (e.g., via computing devices interfacing implementation representative 104 and client 106 to workflow manager 108). For instance, workflow manager 108 may be configured to contemporaneously display implementation documents 146 and/or specific portions thereof to display devices interfacing with each of implementation representative 104 and client 106. During such contemporaneous display, implementation representative 104 and client 106 may be in communication via telephone, electronic chat, videoconference, and/or other electronic means, thus permitting implementation representative 104 and client 106 to communicate regarding completion of implementation documents 166 (e.g., completion of missing information in implementation documents 166) while both are viewing implementation documents 166. Once implementation documents 166 are completed, workflow manager 108 may also be configured to deliver documents on behalf of implementation representative 102 for signature by client 106.

Workflow manager 108 may include any suitable combination of hardware and/or software implemented in one or more modules to provide the described functions and operations. In some embodiments, workflow manager 108 may comprise a general-purpose personal computer (PC), a Macintosh, a workstation, a Unix-based computer, a server computer, or any suitable processing device. In some embodiments, the functions and operations described above may be performed by a pool of multiple workflow managers 108. Workflow manager 108 may include processor 152, memory 154, logic 156, and network interface 158. Workflow manager 108 may also include imaging and indexing software, as well as connections to external imaging devices, printers or fax machines.

Memory 154 may comprise any suitable arrangement of random access memory (RAM), read only memory (ROM), magnetic computer disk, CD-ROM, or other magnetic or optical storage media, or any other volatile or non-volatile memory devices that store one or more files, lists, tables, or other arrangements of information such as implementation documents 146 and customer information 166. Although FIG. 1 illustrates memory 154 as internal to workflow manager 108, it is understood that memory 154 may be internal or external to workflow manager 108, depending on particular implementations. Memory 154 may be separate from or integral to other memory devices to achieve any suitable arrangement of memory devices for use in system 100.

Memory 154 may further be operable to store logic 156. Logic 156 may generally comprise rules, algorithms, code, tables, and/or other suitable instructions for providing the described functions and operations of workflow manager 108. Memory 154 may be communicatively coupled to processor 152. Processor 152 may be generally operable to execute logic 156 to provide the described functions and operations of workflow manager 108. Processor 152 may comprise any suitable combination of hardware and software implemented in one or more modules to provide the described function or operation.

Network interface 158 may communicate information with network 160. Network interface 158 may represent any port or connection, real or virtual, including any suitable hardware and/or software that may enables workflow manager 108 to exchange information with network 60, client 106, sales representative 102, implementation representative 104, and/or or other components of system 100.

Network 160 may represent any number and combination of wireline and/or wireless networks suitable for data transmission. Client 106, sales representative 102, implementation representative 104, and workflow manager 108 may be communicatively coupled via one or more networks 160. Network 160 may, for example, communicate internet protocol packets, frame relay frames, asynchronous transfer mode cells, and/or other suitable information between network addresses. Network 160 may include one or more intranets, local area networks, metropolitan area networks, wide area networks, cellular networks, all or a portion of the Internet, and/or any other communication system or systems at one or more locations.

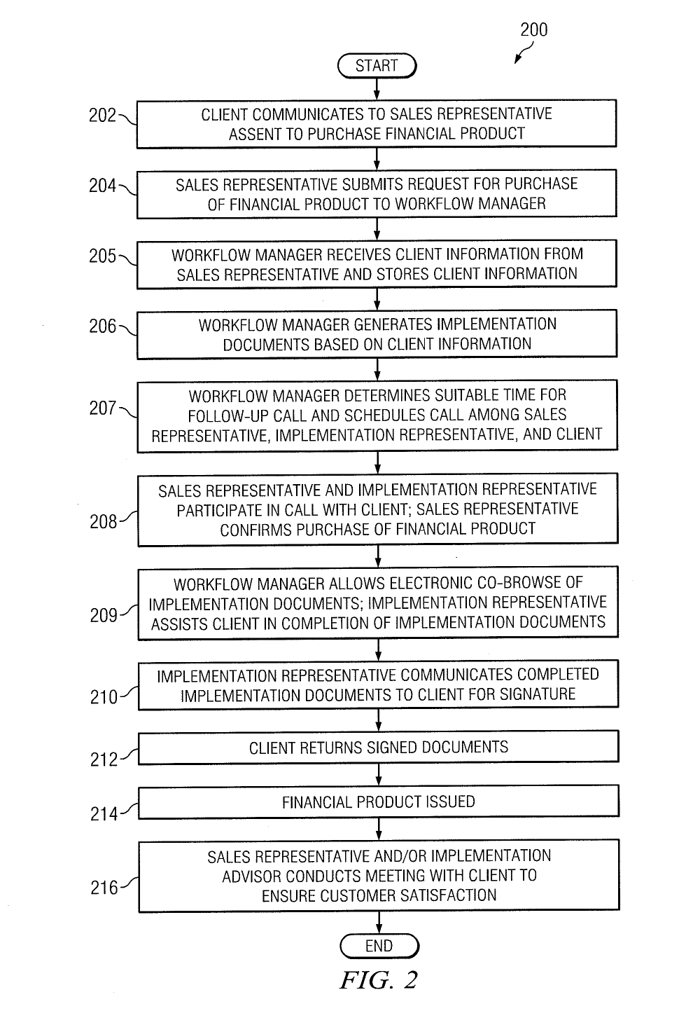

FIG. 2 illustrates a method 200 for coordinated sales and implementation of financial products, in accordance with particular embodiments of the present disclosure. Teachings of the present disclosure may be implemented in a variety of configurations of system 100. As such, the preferred initialization point for method 200 and the order of the steps 202-216 comprising method 200 may depend on the implementation chosen.

At step 202, a client (e.g., client 106) may communicate to a sales representative (e.g., sales representative 102), an assent to purchase a financial product. Such desire may be communicated during a telephone call, via email, via an in-person meeting, or via any other electronic or non-electronic communication. In some embodiments, such assent may be communicated between the client and the sales representative via a workflow manager (e.g., workflow manager 108) or similar device. In addition, in connection with such assent, the client may communicate to the sales representative information regarding availability of the client for a follow-up call regarding implementation of the financial product.

At step 204, in response to the client's desire to purchase a financial product, the sales representative may submit a request for purchase of the financial product to a workflow manager (e.g., workflow manager 108). In particular, the request may be delivered to a workflow manager or other software-based system executing on the computing system and configured to assist the sales representative, the client, an implementation representative, and/or other representatives or employees of a financial institution in completing the transaction for acquisition of the financial product.

At step 205, in connection with the request, the workflow manager may receive from the sales representative client information regarding the client (e.g., client identity and demographic information, financial product to be acquired, availability for follow-up contact, etc.), and store such information (e.g., in memory 154).

At step 206, the workflow manager may, based at least on the client information, generate implementation documents for the financial product to be acquired. For example, based on the financial product to be acquired, the workflow manager may generate one or more implementation documents (e.g., deposit agreements, loan agreements, legal documents, etc.) required by the enterprise (e.g., in accordance with business practices and policies of the enterprise) and/or by applicable law to be completed for issuance of the financial product, and store such implementation documents (e.g., on memory 154). As another example, based on client identity and demographic information, the workflow manager may populate implementation documents with client-specific information to be included in the implementation documents.

At step 207, the workflow manager may, based at least on client information 166 (and possibly also based on availabilities of the sales representative 102 an implementation representative), may determine a suitable time for the implementation representative to contact the client in connection with completion of implementation documents 166, and may accordingly schedule a call or other meeting among the sales representative, the implementation representative, and the client. In addition, the workflow manager may communicate a message regarding the scheduled call to client 106, implementation representative 104, and/or sales representative 102.

At step 208, the sales representative and the implementation advisor may participate in a call or other meeting (e.g., telephonic conversation, video conference, in-person meeting, other electronic communication, or other non-electronic communication) with the client at the scheduled time. During such call, the sales representative may introduce the implementation advisor and/or verify the client's desire to purchase the financial product. In addition, the sales representative may also discuss with the client expectations for implementation of the financial product, including without limitation expected dates of completion for the financial product.

At step 209, the workflow manager may contemporaneously display implementation documents and/or specific portions thereof to display devices interfacing with each of the implementation representative and the client, allowing the implementation representative and the client to electronically co-browse the implementation documents to facilitate completion of implementation documents. During such contemporaneous display, the implementation representative and the client may be in communication via telephonic conversation, video conference, in-person meeting, other electronic communication, or other non-electronic communication, thus permitting the implementation representative and the client to communicate regarding completion of the implementation documents (e.g., completion of missing information in the implementation documents) while both are viewing the implementation documents. Accordingly, the implementation representative may assist the client in completion of the implementation documents.

At step 210, after completion of the implementation documents, implementation representative may communicate (e.g., via email, fax, traditional postal mail, or other suitable manner) the completed implementation documents to the client for the client's signature. In certain embodiments, the completed implementation documents may be communicated via the workflow manager (e.g., the implementation advisor may issue a command to the workflow manager, which may then send an email or other communication to the client including the completed implementation documents).

At step 212, the client may return the signed documents, and at step 214, the financial product may be issued.

At step 216, the sales representative and/or the implementation advisor may conduct a meeting with the client to ensure customer satisfaction. For example, during such follow-up meeting, the sales representative and/or implementation advisor may inquire as to whether the client is satisfied with the financial product, requires additional training information about the financial product, or any other topic relevant to the client's acquisition of the financial product.

Although FIG. 2 discloses a particular number of steps to be taken with respect to method 200, method 200 may be executed with greater or lesser steps than those depicted in FIG. 2. In addition, although FIG. 2 discloses a certain order of steps to be taken with respect to method 200, the steps comprising method 200 may be completed in any suitable order. In addition, the steps comprising method 200 may be repeated, independently and/or collectively, as often as desired or required by a chosen implementation.

What is claimed is:

1. An apparatus, comprising:
a network interface configured to receive a request for a client's purchase of a financial product, the request including client information; and
a processor coupled to the network interface, the processor configured to execute logic to:
generate implementation documents based at least on the client information, the implementation documents comprising documents to be completed as a prerequisite to issuance of the financial product;
schedule a follow-up meeting relating to purchase of the financial product based at least on the client information; and
contemporaneously electronically display implementation documents to a client and an implementation advisor to facilitate the implementation advisor's assistance to the client in completing the implementation documents.

2. An apparatus according to claim 1, wherein the client information includes at least one of client identity, client demographic information, information regarding the financial product to purchased, and client availability for follow-up contact.

3. An apparatus according to claim 1, the processor further configured to execute logic to communicate completed implementation documents from the implementation advisor to the client.

4. An apparatus according to claim 1, the network interface configured to receive the request for the client's purchase of the financial product from a sales representative who solicited the purchase of the financial product.

5. An apparatus according to claim 1, the processor configured to execute logic to schedule the follow-up meeting based at least on availability of the implementation advisor.

6. A apparatus according to claim 5, wherein scheduling the follow-up meeting is further based at least on availability of a sales representative who solicited the purchase of the financial product.

7. A tangible computer readable medium comprising logic, the logic configured to, when executed on a processor:
receive a request for a client's purchase of a financial product, the request including client information;
generate implementation documents based at least on the client information, the implementation documents comprising documents to be completed as a prerequisite to issuance of the financial product;
schedule a follow-up meeting relating to purchase of the financial product based at least on the client information; and
contemporaneously electronically display implementation documents to a client and an implementation advisor to facilitate the implementation advisor's assistance to the client in completing the implementation documents.

8. A tangible computer readable medium according to claim 7, wherein the client information includes at least one of client identity, client demographic information, information regarding the financial product to purchased, and client availability for follow-up contact.

9. A tangible computer readable medium according to claim 7, further comprising communicating, by the workflow manager, completed implementation documents from the implementation advisor to the client.

10. A tangible computer readable medium according to claim 7, wherein the request for the client's purchase of the financial product is received from a sales representative who solicited the purchase of the financial product.

11. A tangible computer readable medium according to claim 7, wherein scheduling the follow-up meeting is further based at least on availability of the implementation advisor.

12. A tangible computer readable medium according to claim 11, wherein scheduling the follow-up meeting is further based at least on availability of a sales representative who solicited the purchase of the financial product.

13. A method comprising:
receiving, by a workflow manager, a request for a client's purchase of a financial product, the request including client information;
generating, by the workflow manager, implementation documents based at least on the client information, the implementation documents comprising documents to be completed as a prerequisite to issuance of the financial product;
scheduling, by the workflow manager, a follow-up meeting relating to purchase of the financial product based at least on the client information; and
contemporaneously electronically displaying, by the workflow manager, implementation documents to a client and an implementation advisor to facilitate the implementation advisor's assistance to the client in completing the implementation documents.

14. A method according to claim 13, wherein the client information includes at least one of client identity, client demographic information, information regarding the financial product to purchased, and client availability for follow-up contact.

15. A method according to claim 13, further comprising communicating, by the workflow manager, completed implementation documents from the implementation advisor to the client.

16. A method according to claim 13, wherein the request for the client's purchase of the financial product is received from a sales representative who solicited the purchase of the financial product.

17. A method according to claim 13, wherein scheduling the follow-up meeting is further based at least on availability of the implementation advisor.

18. A method according to claim 17, wherein scheduling the follow-up meeting is further based at least on availability of a sales representative who solicited the purchase of the financial product.
